(19) United States
(12) Patent Application Publication
(10) Pub. No.: US 2020/0067210 A1
(43) Pub. Date: Feb. 27, 2020

(54) A BIMETAL END SLEEVE

(71) Applicant: ZAKLAD APARATURY ELEKTRYCZNEJ ERGOM SP. Z O.O., Lodz (PL)

(72) Inventors: Bogdan TOMASZEK, Lodz (PL); Marek OPAS, Lodz (PL)

(21) Appl. No.: 16/466,646

(22) PCT Filed: Dec. 1, 2017
(86) PCT No.: PCT/EP2017/081156

§ 371 Date: Jun. 5, 2019

(30) Foreign Application Priority Data
Dec. 7, 2016 (PL) W.125817

(51) Int. Cl. H01R 4/20; H01R 4/22; H01R 4/62

(52) U.S. Cl. CPC H01R 4/20; H01R 4/62; H01R 4/22

(57) ABSTRACT

A bimetal end sleeve for connecting an electrical wire to a terminal of an electrical apparatus. The sleeve has an inner layer and an outer layer. The outer layer is made of a first metal, that is not subject to galvanic corrosion when in contact with the terminal of the electrical apparatus. The inner layer is made of a second metal, that is not subject to galvanic corrosion when in contact with a conductor of the electrical wire. The bimetal end sleeve is made of a bimetal tube, a bimetal strip or a bimetal sheet metal that is shaped to a form, in which the inner layer and the outer layer are bonded together. Both layers have a form of tubes having a continuous surface. Each layer has a thickness equal at least 30% of a total thickness of the two layers.

### TECHNICAL FIELD

The present invention relates to a bimetal end sleeve for connecting an electric wire to a terminal of an electric apparatus.

### BACKGROUND

End sleeves are used for terminating conductors of electric wires, in particular wires in which conductors have a form of stranded wires consisting of twisted thin wires. After applying the end sleeve on the conductor, the end sleeve is crimped by a special tool to compress the stranded wire inside the end sleeve. This integrates the end sleeve with the wire and facilitates electrical connection of the wire with a terminal of an electrical apparatus to which the wire is to be connected. Use of end sleeves also protects the wires against damage when connecting them to the terminal of the apparatus.

Commonly used end sleeves typically have a form of a thin wall metal tube, usually having a funnel-shaped flaring at one end.

There are also known insulated end sleeves, comprising additional plastic (non-conductive) sleeve mounted on a metal part of the end sleeve. That additional plastic sleeve is used to improve the protection of the wire and to increase the safety of the operator who installs the wire.

Commonly used end sleeves are usually made of copper and are most suitable for wires having conductors also made of copper.

One drawback of the known end sleeves is that when an end sleeve made of copper is fixed on a conductor made of another material, for example aluminum, galvanic corrosion, also called a contact corrosion, occurs in the points of contact between these two metals, when exposed to an electrolyte (such as an environment comprising vapor), which leads to damage of the conductor or of the end sleeve.

The galvanic corrosion is caused by direct contact of two metals or alloys having different potentials, which therefore form a galvanic cell. The efficiency of the galvanic cell increases with the increase of a potential difference of the contacting metals in the corrosive environment. A connection of metal having a first electrochemical potential with another metal having a different, second electrochemical potential, in the presence of the electrolyte (for example water with dissolved ions) results in that the metal having the lower potential is subject to an intensive dissolution. The metallic areas which corrode faster are also referred to as an anode of the galvanic cell.

Similar situation occurs when a copper wire with an end sleeve crimped at its end is connected to an apparatus terminal made of another material, for example aluminum or aluminum alloy. Typically, this will result in a progressive damage to the end sleeve or to the apparatus terminal.

Such phenomena may occur in particular when elements made of metals having different electrochemical potential are exposed to an environment comprising vapor.

Typical end sleeves are defined for example in a “DIN 46228 teil 1” standard. End sleeves with additional insulation are defined for example in a the “DIN 46228 teil 4” standard.

There are also known bimetal end sleeves.

For example, there is known an end sleeve model CUPAH GL made by DEHN+SÖHNE GmbH+Co. KG (Germany), which has a form of a tube made of a folded bimetal sheet, consisting of two bonded layers: an outer copper layer and an inner aluminum layer. The tube has free longitudinal edges, and therefore it cannot be effectively crimped on a conductor of the wire.

There is also known an end sleeve model CH made by Dietzel Univolt Deutschland GmbH (Germany). The end sleeve is similar to CUPAH GL by DEHN+SOHNE as described above, but its outer layer is made of aluminum and the inner layer is made of copper. Therefore, it has the same drawbacks. It is suitable for separating the conductor from the apparatus terminal, but it is not suitable for effective crimping on the conductor of the wire.

A U.S. Pat. No. 4,210,381 discloses an electrical connector contact elements, in which a tubular member of an aluminum material is captured within a surrounding member of a copper material. The tubular member has a bore for receiving a cable conductor to which the contact element will be crimped and the surrounding member including a further connector portion for connection to a further conductive member, the tubular member being in intimate electrical connection with the surrounding member and remaining in such intimate connection throughout a range of operating temperatures. The copper element is in exact contact with the aluminum element under a wide range of temperatures, however the elements are not bonded together, but only connected by deformation. Therefore, the connection solves the problem of achieving appropriate properties under different thermal expansions of the materials used, but is not completely hermetic and therefore the connector is prone to electrochemical corrosion.

A U.S. Pat. No. 4,908,943 discloses a method of forming lead or lead alloy terminals on cables comprising an isolating sheath and an aluminum core. An appropriate length of the core is bared and a metal part is fixed to the bared core. The terminal is then cast over this metal part. The metal part is compatible externally with the lead or the lead alloy forming the terminal and is compatible internally with the aluminum core. No high-resistivity substance is formed between any component layers of the resulting assembly. The production process of such terminal is quite complicated. Moreover, the outer layer, formed by casting is significantly thinner than the inner layer, therefore it is prone to mechanical damage and may easily uncover the inner layer.

Therefore, there is a need to provide an alternative structure of a bimetal end sleeve, to solve at least part of the above mentioned problems, in particular to increase its resistance to galvanic corrosion.

### SUMMARY

There is disclosed a bimetal end sleeve for connecting an electrical wire to a terminal of an electrical apparatus, the bimetal end sleeve comprising an inner layer and an outer layer, wherein the outer layer is made of a first metal, that is not subject to galvanic corrosion when in contact with the terminal of the electrical apparatus, whereas the inner layer is made of a second metal, that is not subject to galvanic corrosion when in contact with a conductor of the electrical wire, characterized in that the bimetal end sleeve is made of a bimetal tube, a bimetal strip or a bimetal sheet metal that is shaped to a form, in which the inner layer and the outer layer are bonded together, wherein both layers have a form of tubes having a continuous surface, and wherein each layer has a thickness equal at least 30% of a total thickness (G) of the two layers.

At one end the sleeve may comprise a funnel-shaped flaring.

Next to the funnel-shaped flaring the sleeve may have an elongated front portion.

The elongated front portion can be terminated with a funnel-shaped flaring.

At a rear end the sleeve may comprise a bimetal cap.

The sleeve may comprise an insulation sleeve made of plastic, which surrounds at least a front portion of the end sleeve from the outside.

### BRIEF DESCRIPTION OF DRAWINGS

The invention is shown by means of example embodiments on a drawing, in which:

FIG. 1 presents a first embodiment of an end sleeve;

FIG. 2 presents a second embodiment of an end sleeve;

FIG. 3 presents a third embodiment of the end sleeve;

FIG. 4 presents a fourth embodiment of the end sleeve;

FIG. 5 presents a fifth embodiment of the end sleeve;

FIG. 6 presents a sixth embodiment of the end sleeve;

FIG. 7 presents a seventh embodiment of the end sleeve;

FIG. 8 presents an eight embodiment of the end sleeve.

### DETAILED DESCRIPTION

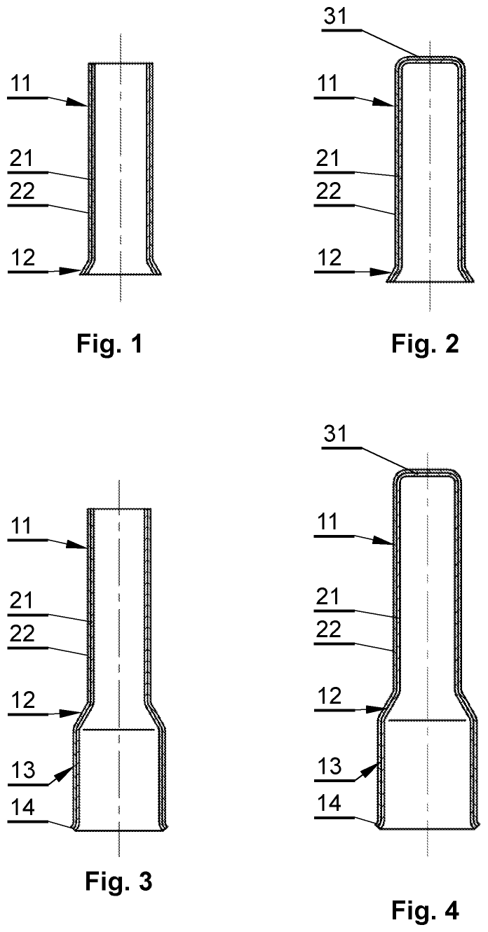

A bimetal end sleeve in a first, simple embodiment, is shown in a longitudinal cross-section in FIG. 1. The end sleeve has a cylindrical portion 11. The cylindrical portion 11 may be terminated with a funnel-shaped flaring 12 at the front end of the sleeve (i.e. at the side at which the wire is inserted into the end sleeve) to facilitate the insertion of the conductor of the wire into the end sleeve. The bimetal end sleeve has a form of a tube having a continuous surface comprising two bonded layers, preferably bonded on the whole surface. The term bonding as used herein is meant to cover cold bonding or hot bonding of the metal surfaces. The exact bonding of the layers is important, to provide effective current conduction and protection against corrosion. The appropriate bonding of layers may be achieved for example by plating or electric resistance welding. The outer layer 22 is made of a first metal, that is not subject to (in other words, does not cause) galvanic corrosion when in contact with a terminal of an electrical apparatus, wherein the inner layer 21 is made of a second metal, that is not subject to (in other words, does not cause) galvanic corrosion when in contact with a conductor of the electrical wire.

For example, for a wire with an aluminum conductor, which is to be connected to an apparatus having a terminal made of copper or a copper alloy, it is preferable that the first metal of the outer layer 22 (which is in contact with the apparatus terminal) is copper or a copper alloy, while the second metal of the outer layer 21 (which is in contact with the conductor of the wire) is aluminum or an aluminum alloy. Such structure of the end sleeve allows to avoid the galvanic corrosion at the place of contact of the end sleeve and the wire, as well as at the place of contact of the end sleeve and the electrical apparatus.

The term bimetal as used herein is understood to cover a laminate of two dissimilar metals, having different physical or chemical properties, which are bonded together.

The bimetal end sleeve according to the invention may be made of, for example, an element cut from a bimetal sheet or from a bimetal strip and shaped into a form of a tube by drawing. The bimetal end sleeve according to the invention may be also made for example from a bimetal seamless tube (preferably made in a process of drawing) by cutting it to a desired length. The bimetal end sleeve made in a process of drawing has, among other advantages, excellent isolation between the surfaces of the two metals, uniform structure and is efficient to manufacture.

Each layer 21, 22 has a thickness g1, g2 being at least a 30% of a total thickness of both layers. Owing to this, both layers offer a high mechanical strength and it is difficult to damage one layer to such an extent that would cause a risk of uncovering the second layer. In one embodiment, the inner layer is thicker than the outer layer. In another embodiment the outer layer is thicker than the inner layer. In yet another embodiment, both layers have the same thickness.

FIG. 2 presents the end sleeve in a second embodiment. As compared to the first embodiment presented in FIG. 1, the second embodiment comprises a bimetal cap 31 at the rear end of the end sleeve (i.e. at the opposite side to the side at which the wire is introduced into the sleeve), which closes the sleeve at the rear end. The bimetal cap 31 enhances the protection against corrosion, by protecting the interior of the end sleeve against access of the or moisture from the air. The bimetal cap 31 also prevents contact of the wire end with the terminal, which could cause the galvanic corrosion.

FIG. 3 presents the end sleeve in a third embodiment. As compared to the first embodiment presented in FIG. 1, in the third embodiment the end sleeve further comprises an elongated front portion 13 in a form of the tube which is be smoothly joined with the funnel-shaped flaring 12, and which protects the insulation of the wire introduced to the end sleeve. Moreover, the front portion 13 may terminate with a funnel-shaped flaring 14, which facilitates introducing the insulation of the wire into to the interior of the portion 13.

FIG. 4 presents the end sleeve in a fourth embodiment, wherein as compared to the first embodiment presented in FIG. 1, the end sleeve comprises the bimetal cap 31 (similarly to the second embodiment) and the elongated front portion 13 (similarly to the third embodiment).

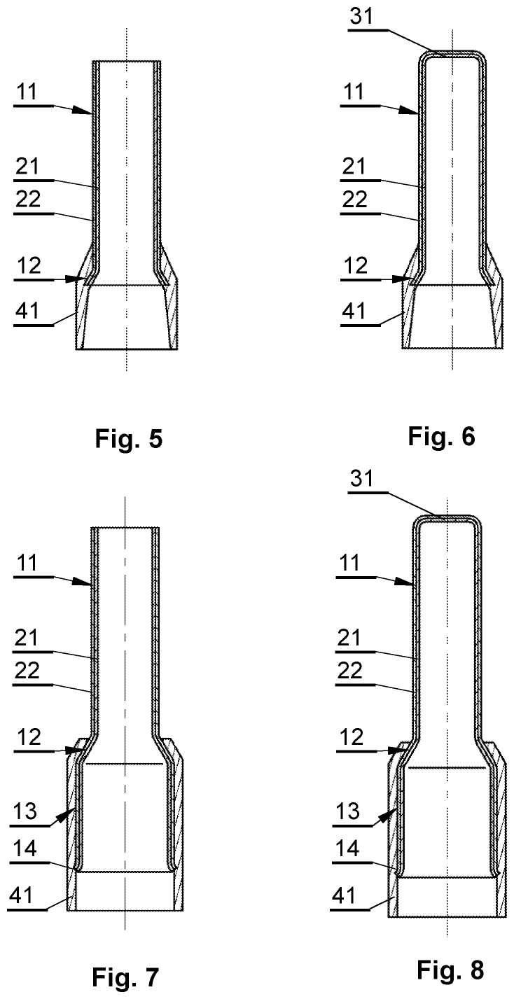

FIG. 5 presents the end sleeve in a fifth embodiment, wherein as compared to the first embodiment presented in FIG. 1, the end sleeve comprises an insulation sleeve 41 in a form of the plastic sleeve surrounding the front portion of the bimetal sleeve, in particular positioned on the funnel-shaped flaring 12, which extends beyond the bimetal end sleeve at the front side of the end sleeve. The insulation sleeve provides additional protection of the wire insulation and increases the safety of an operating personnel.

FIG. 6 presents the end sleeve in a sixth embodiment, wherein as compared to the first embodiment presented in FIG. 1, the end sleeve comprises the bimetal cap 31 (similarly to the second embodiment) and the insulation sleeve 41 (similarly to the fifth embodiment).

FIG. 7 presents the end sleeve in a sixth embodiment, wherein as compared to the first embodiment presented in FIG. 1, the end sleeve comprises the elongated front portion 13 (similarly to the third embodiment) and the insulation sleeve 41 (similarly to the fifth embodiment).

FIG. 8 presents the end sleeve in an eight embodiment, wherein as compared to the first embodiment presented in FIG. 1, the end sleeve comprises the bimetal cap 31 (similarly to the second embodiment), the elongated front portion 13 (similarly to the third embodiment) and the insulation sleeve 41 (similarly to the fifth embodiment).

All of the presented embodiments comprise elements in common with the first embodiment. The embodiments from the second to the eight are to be considered as variants of the first embodiment comprising additional elements with respect to the first embodiment. Other embodiments of the end sleeve according to the invention are also possible, comprising a combination of two or more additional elements indicated in the presented embodiments from the second to the eight, providing a juxtaposition of the advantages arising from the features of particular elements.

1. A bimetal end sleeve for connecting an electrical wire to a terminal of an electrical apparatus comprising: an inner layer and an outer layer, wherein the outer layer is made of a first metal, that is not subject to galvanic corrosion when in contact with the terminal of the electrical apparatus, whereas the inner layer is made of a second metal, that is not subject to galvanic corrosion when in contact with a conductor of the electrical wire, wherein the bimetal end sleeve is made of a bimetal tube, a bimetal strip or a bimetal sheet metal that is shaped to a form, in which the inner layer and the outer layer are bonded together, wherein both layers have a form of tubes having a continuous surface, wherein each layer has a thickness equal to at least 30% of a total thickness of the two layers, and wherein one end of the bimetal end sleeve includes a funnel-shaped flaring.

2. (canceled)

3. The bimetal end sleeve according to claim 1, wherein an elongated front portion is positioned next to the funnel-shaped flaring.

4. The bimetal end sleeve according to claim 3, wherein the elongated front portion is terminated with a funnel-shaped flaring.

5. The bimetal end sleeve according to claim 1, additionally comprises a bimetal cap at its rear end.

6. The bimetal end sleeve according to claim 1, additionally comprises an insulation sleeve made of plastic, which surrounds at least a front portion of the end sleeve from the outside.
